(19) United States
(12) Patent Application Publication
(10) Pub. No.: US 2008/0154940 A1
(43) Pub. Date: Jun. 26, 2008

(54) SYSTEM AND METHOD FOR USING XQUERY FILES AS A MIDDLEWARE TO PROVIDE WEB SERVICES

(75) Inventors: CHUNG-I LEE, Tu-Cheng (TW); Chien-Fa Yeh, Tu-Cheng (TW); Chiu-Hua Lu, Tu-Cheng (TW); Wei-Qing Xiao, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/933,435

(22) Filed: Nov. 1, 2007

(30) Foreign Application Priority Data
Dec. 20, 2006 (CN) 200610157694.5

(51) Int. Cl. G06F 7/00

(52) U.S. Cl. 707/102; 707/E17.045

(57) ABSTRACT

A system for using XQuery files as a middleware to provide Web services is provided. The system includes a Web server. The Web server includes: an XQuery file definition module 410 programmed for defining an XQuery file, including defining input parameters for accepting data from data sources and defining addresses of the data sources; an XQuery file parsing module programmed for extracting the input parameters from the XQuery file and parsing the XQuery file according to the input parameters to create a source file of the Web service; a compiling module programmed for compiling the source file to an executable file of the Web service; and a WSDL file generating module programmed for generating a WSDL file of the Web service according to the executable file. A related method is also provided.

### BACKGROUND OF THE INVENTION

1. Field of the Invention

The present invention is related to systems and methods for providing Web services, more particularly, to a system and method for using XQuery files as a middleware to provide Web services.

2. Description of Related Art

Web services are well known in the computer software field. Generally a Web service is a computer application (software) component accessible by other computer applications based on open protocols. Thus, Web services are intended for purposes of interoperability between different computer applications, for instance for business-to-business integration.

More precisely a Web service is an application component that communicates via open protocols, processes XML (short for The Extensible Markup Language) messages, describes the XML messages using XML schema, and provides an endpoint description using the Web service description language (WSDL). WSDL makes it possible to describe an endpoint for a message and its behavior. Furthermore, WSDL provides additional information over the XML schema definitions that describe actual messages. Hence WSDL provides meta-information about, for instance, a computer file to be accessed.

Typically the Web service is used to access objects in another organization's computer system. What is accessed is generally referred to herein as a software object. A software object includes data and/or operations from the other organization's computer system. The access is typically over the Internet. The data sources accessed may be a single field of data, a group of fields of data, or a table of data. Usually, in a design of an application program for a Web service, it is necessary to develop specific access programs for accessing different types of data sources, such as XML databases, relational databases, XML files and Web pages by the application program. The conventional solution is inconvenient and inefficient because a program developer would need to develop many different kinds of access programs.

What is needed, therefore, is a system and method for taking XQuery files as a middleware to provide Web services, so as to realize accessing data from different types of the data sources.

### SUMMARY OF THE INVENTION

One preferred embodiment provides a system for taking XQuery files as a middleware to provide Web services. The system includes a Web server. The Web server includes: an XQuery file definition module 410 programmed for defining an XQuery file, including defining input parameters for accepting desired data from data sources and defining addresses of the data sources; an XQuery file parsing module programmed for extracting the input parameters from the XQuery file and parsing the XQuery file according to the input parameters to create a source file of the Web service; a compiling module programmed for compiling the source file to an executable file of the Web service; and a WSDL file generating module programmed for generating a WSDL file of the Web service according to the executable file.

Another preferred embodiment provides a method for taking XQuery files as a middleware to provide Web services. The method includes steps of: (a) defining an XQuery file, including defining input parameters for accepting desired data from data sources and defining addresses of the data sources; (b) extracting the input parameters from the XQuery file; (c) parsing the XQuery file according to the input parameters to create a source file of the Web service; (d) compiling the source file to an executable file of the Web service; and (e) generating a WSDL file of the Web service according to the executable file.

Other objects, advantages and novel features of the present invention will be drawn from the following detailed description of the preferred embodiment and preferred method of the present invention with the attached drawings.

### BRIEF DESCRIPTION OF THE DRAWINGS

FIG. 1 is a schematic diagram of hardware configuration of a system for using XQuery files as a middleware to provide Web services in accordance with one preferred embodiment;

FIG. 2 is a schematic diagram of function modules of a Web server in FIG. 1; and

FIG. 3 is a flowchart of a method for using XQuery files as a middleware to provide Web services in accordance with one preferred embodiment.

### DETAILED DESCRIPTION OF THE INVENTION

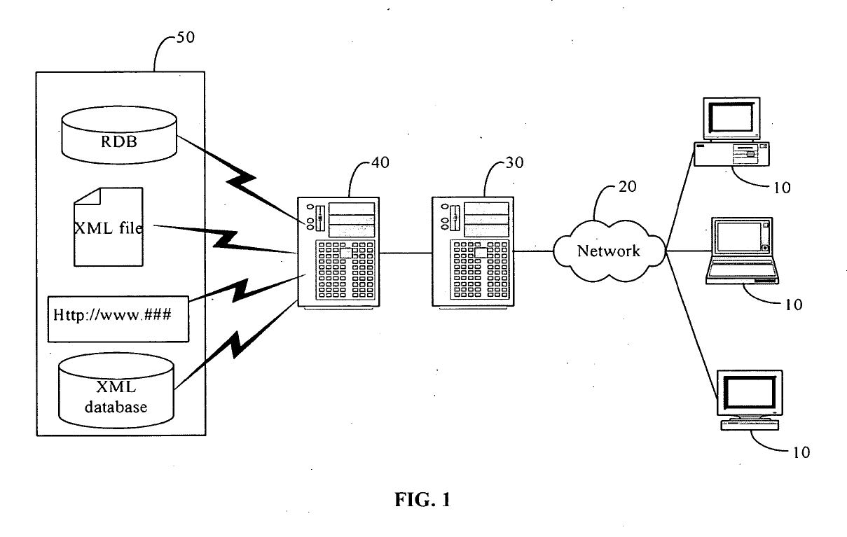

FIG. 1 is a schematic diagram of hardware configuration of a system for using XQuery files as a middleware to provide Web services in accordance with one preferred embodiment. In this preferred embodiment, the hardware configuration includes one or more client computers 10, a universal description, discovery, and integration server 30 (hereinafter, “UDDI server 30”), a Web server 40 and a plurality of different types of data sources 50. The data sources 50 are connected with the Web server 40, and the Web server 40 is further connected to the UDDI server 30. The client computers 10 connect with the UDDI server 30 via a network 20.

Each of the client computers 10 may be a notebook computer, a desktop computer, a personal digital assistant (PDA), or any other terminal access device.

The network 20 may be an intranet, the Internet, or any other suitable type of communications link.

The data sources 50 may be relational databases (RDB) (such as IBM DB2, IBM UDB, Oracle, SQL server), XML files, XML databases, or Web pages, and so on. The data source 50 provides data accessible by the Web server 40.

The Web server 40 and the UDDI server 30 may be desktop servers, rack mount servers, pedestal servers, or blade servers. The UDDI server 30 is configured for storing WSDL files of Web services. The Web server 40 is configured for providing an executable file for each Web service. The client computers 10 sends a request to invoke the executable file of the Web service in the Web server 40, based on a corresponding WSDL file in the UDDI server 30. Then the Web server 40 retrieves desired data of the Web service from the predetermined data source 50, inputs the desired data to corresponding predetermined input parameters of the Web service and sends the results to the client computers 10.

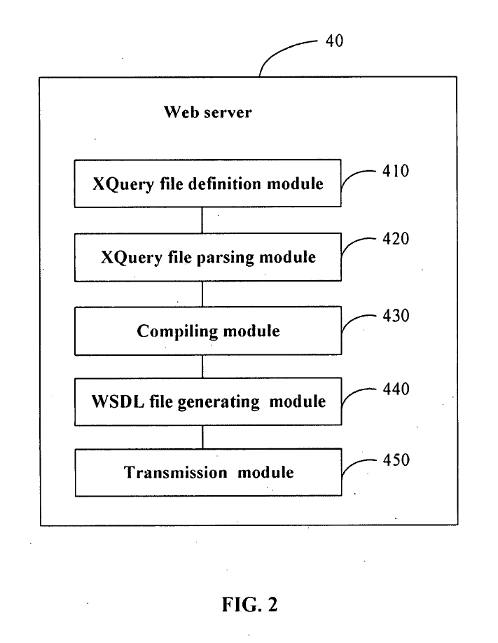

FIG. 2 is a schematic diagram of function modules of the Web server 40. The Web server 40 includes: an XQuery file definition module 410, an XQuery file parsing module 420, a compiling module 430, a WSDL file generating module 440, and a transmission module 450.

The XQuery file definition module 410 is programmed for defining an XQuery file, including defining input parameters for accepting desired data from data sources 50, such as “declare variable $currency external”, and defining addresses of the data sources 50, such as “<address>http://tw.stock.yahoo.com/d/c/ex.php</address>”.

The XQuery file parsing module 420 is programmed for extracting the input parameters from the XQuery file, parsing the XQuery file according to the input parameters to create a source file of the Web service. The source file can be in any kind of programming languages, such as JAVA or C#.

The compiling module 430 is programmed for compiling the source file to an executable file for the Web service.

The WSDL file generating module 440 is programmed for generating a WSDL file of the Web service according to the executable file.

The transmission module 450 is programmed for transmitting the WSDL file to the UDDI server 30.

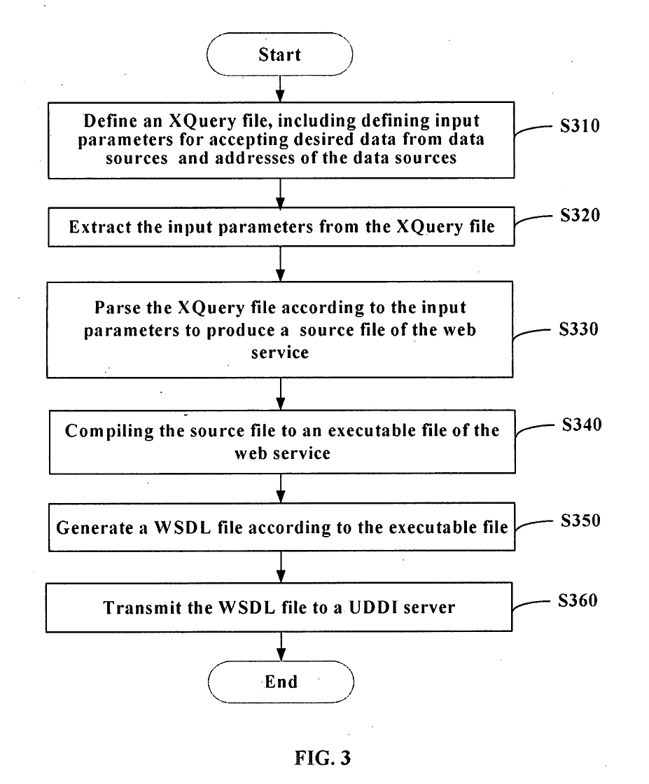

FIG. 3 is a flowchart of a method for using XQuery files as a middleware to provide Web services in accordance with one preferred embodiment. In step S310, the XQuery file definition module 410 defines the XQuery file, including defining input parameters for accepting desired data from data sources 50 and defining addresses of the data source 50, such as “<address>http://tw.stock.yahoo.com/d/c/ex. php</address>”.

In step S320, the XQuery file parsing module 420 extracts the input parameters from the XQuery file.

In step S330, the XQuery file parsing module 420 parses the XQuery file according to the input parameters to create a source file of the Web service. The source file can be in any kind of programming language, such as JAVA or C#.

In step S340, the compiling module 430 compiles the source file to an executable file for the Web service.

In step S350, the WSDL file generating module 440 generates a WSDL file of the Web service according to the executable file.

In step S360, the transmission module 450 transmits the WSDL file of the Web service to the UDDI server 30.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for using XQuery files as a middleware to provide Web services comprising a Web server, the Web server comprising:
an XQuery file definition module programmed for defining an XQuery file, including defining input parameters for accepting desired data from data sources and defining addresses of the data sources;
an XQuery file parsing module programmed for extracting the input parameters from the XQuery file, and parsing the XQuery file according to the input parameters to create a source file of the Web service;
a compiling module programmed for compiling the source file to an executable file of the Web service; and
a WSDL file generating module programmed for generating a WSDL file of the Web service according to the executable file.

2. The system as claimed in claim 1, wherein the Web server further comprises a transmission module programmed for transmitting the WSDL file to a UDDI server.

3. The system as claimed in claim 1, wherein the data sources are relational databases, XML files, XML databases or Web pages.

4. A method for using XQuery files as a middleware to provide Web services, the method comprising:
defining an XQuery file, including defining input parameters for accepting data from data sources and defining addresses of the data sources;
extracting the input parameters from the XQuery file;
parsing the XQuery file according to the input parameters to create a source file of the Web service;
compiling the source file to an executable file of the Web service; and
generating a WSDL file of the Web service according to the executable file.

5. The method as claimed in claim 4, further comprising:
transmitting the WSDL file to a UDDI server.
